(19) United States
(12) Patent Application Publication
(10) Pub. No.: US 2010/0239091 A1
(43) Pub. Date: Sep. 23, 2010

(54) METHOD FOR GENERATING MASKS IN A COMMUNICATING OBJECT AND CORRESPONDING COMMUNICATING OBJECT

(75) Inventors: Frederic Amiel, Carnoux (FR); Laurent Gauteron, marignane (FR)

Correspondence Address: BUCHANAN, INGERSOLL & ROONEY PC, POST OFFICE BOX 1404, ALEXANDRIA, VA, 22313-1404, US

(73) Assignee: Gemalto SA, Meudon (FR)

(21) Appl. No.: 12/680,242

(22) PCT Filed: Aug. 27, 2008
(86) PCT No.: PCT/EP2008/061242

§ 371 Date: Apr. 15, 2010

(30) Foreign Application Priority Data
Sep. 28, 2007 (EP) 07301410.2

(51) Int. Cl. H04K 1/02

(52) U.S. Cl. 380/252

(57) ABSTRACT

The invention relates to a method for generating masks in a communicating object, the masks being intended to mask data to be stored in the communicating object. At least one master mask is stored in the communicating object. According to the invention, the method involves applying at least one diversifier to the master mask so as to generate a diversified mask; masking the datum to be stored in the communicating object by a reversible function using the diversified mask, the mask generating a masked datum; and storing the masked datum in the communicating object with the diversifier used to generate the diversified mask for obtaining the masked datum. The invention also relates to a communicating object including components for implementing such a method.

The field of the invention is that of communicating objects such as, more particularly, chip cards, cellular telephones or PDAs. More precisely, the present invention relates to a method for generating masks in a communicating object.

In the following description, “mask” will refer to a digital function intended to mask a sensitive datum or instructions of a programme desired to be kept secret in the communicating object. In the field of chip cards, such a datum is for example a key, a code, an identifier of the owner of the card or an algorithm or instructions that are desirably not disclosed to a possible attacker. Such data are thus not stored “encoded” in the card.

In order to mask a sensitive datum in a chip card, it is known to apply a mathematic function to such sensitive datum. The resulting datum is then a masked datum which is stored in the memory of the card. Subsequently, if such a sensitive datum is desirably read, a mathematical function which is the reverse of the preceding one is applied to the masked datum and the sensitive datum can then be restored to be used, for example for executing a programme.

The mathematical function is for example an Exclusive-Or.

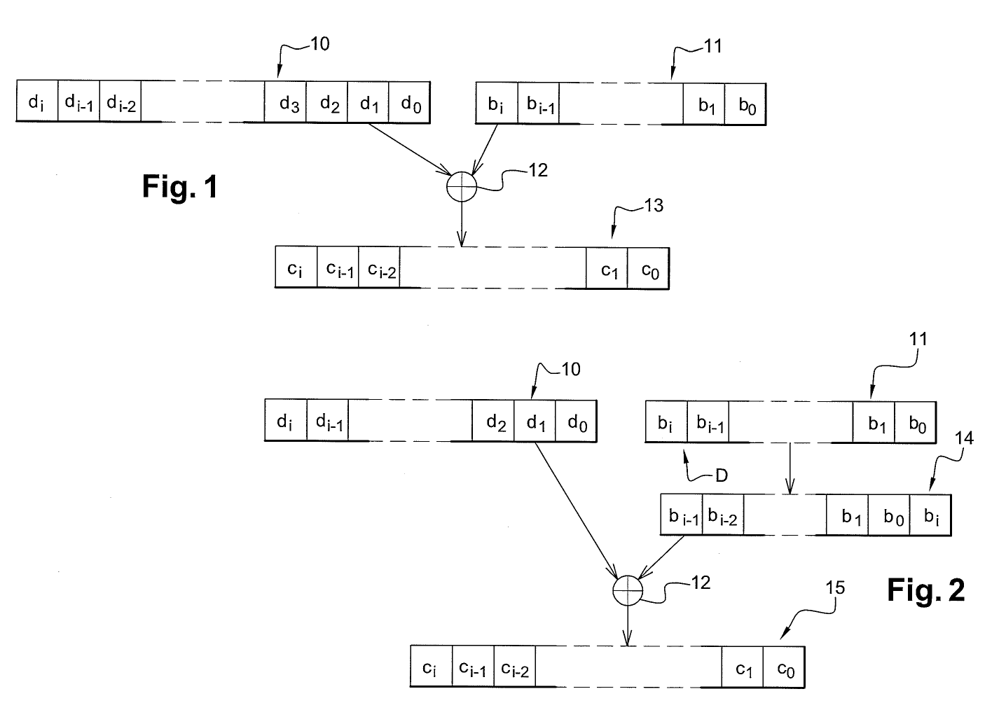

FIG. 1 shows the masking of a datum 10 including i bytes d₀ to d_{I}. The mask used for masking the datum 10 is indicated by 11 and also includes i bytes b₀ to b_{I}. The masking function is here an Exclusive-or function 12. The masked datum is indicated by 13 and includes i bytes c₀ to c_{I} with c_{I}=d_{I}+b_{I}. The masking thus consists in performing a byte-oriented Exclusive-or.

When applying the mask 11 to the masked datum 13 by the Exclusive-or function, the datum 10 is regenerated since the Exclusive-or function is reversible.

The drawback of such known solution is that it is possible for an attacker to find the mask 11 by injecting mistakes into the communicating object, for example a chip card or by exploiting malfunctions thereof. Such attacks are also called “dump” attacks. If the mask 11 is disclosed to the attacker, the latter will have no particular difficulty to read all the masked data stored in the communicating object.

A solution for remedying such drawback linked to the presence of a unique mask consists in providing several masks in the communicating object and in changing the mask as a function of the application or the type of data to be masked. Such solution however has the drawback of requiring the storing of several masks in the communicating object, which can hardly be considered when the memory resource is small, as is the case in chip cards.

The present invention aims at remedying such drawback.

More precisely, one of the objectives of the invention is to provide a method for masking data in a communicating object making it possible to mask a very large number of data without requiring storing more than one mask or at least a very high number of masks.

This objective, as well as others, which will appear in the following, is reached thanks to a method for generating masks in a communicating object, the masks being intended to mask data to be stored in the communicating object, with at least one master mask being stored in the communicating object, the method consisting in:
applying at least one diversifier to the master mask so as to generate a diversified mask;
masking the data to be stored in the communicating object by a reversible function using the diversified mask, the masking generating a masked datum;
storing the masked data in the communicating object together with the diversifier used to generate the diversified mask for obtaining the masked datum.

The application of diversifiers to the master mask thus makes it possible to obtain diversified masks which are used to mask the data.

Preferably, the reversible function used is an Exclusive-Or function.

Advantageously, the application of a diversified master mask consists in applying a rotation to the master mask. Thus, the generation of diversified masks consists of simple rotations of the master masks. For a 256-byte master mask, it will thus be possible to generate 256 different masks if the rotation is byte-oriented. It is well understood that it is also possible to perform rotations at the bit level, which further increases the number of different masks which can be generated.

The diversifier is preferably generated in a pseudo-random manner in the communicating object. This has the advantage of being capable of masking the data on the fly.

Advantageously, the master masks are diversified from one communicating object to another. Thus, even though an attacker succeeds in finding the master mask of a communicating object, he/she will not be able to unmask the data stored in another communicating object since the master masks thereof are different.

The invention also relates to a communicating object including means for implementing such a method.

The communicating object preferably consists of a chip card.

Other advantages and characteristics of the present invention will appear when reading the following description of a preferred embodiment given as an illustration and not as a limitation, and the appended drawings wherein:

FIG. 1 shows the principle of the masking of a datum as per the state of the art;

FIG. 2 shows a preferred embodiment of the method according to the invention.

FIG. 1 has been previously described while referring to the state of the art.

FIG. 2 shows a preferred embodiment of the method according to the invention.

In this preferred embodiment, a mask 11, also called a master mask, is used. The master mask 11 is stored in the communicating object. The invention proposes to apply a diversifier D to the master mask 11 so as to generate a diversified mask 14.

In a preferred embodiment, the diversifier D is a simple pointer which marks the byte of the master mask 11, which will be used to mask the first byte of the datum 10. In FIG. 2, the diversifier D points to the byte b_{I-1} and this byte will be the first one of the diversified mask. The other bytes are taken one after the other in a simplified embodiment. Thus, a diversified mask 14 is obtained, the first byte of which is b_{I-1} and the last byte is b_{I}. Then, a rotation will have simply been applied to the bytes of the master mask 11. It is also possible to apply rotations to the bits of the master mask 11, with the rotation being bits-oriented then.

Then, the bytes d₀ to d₁ of the data 10 are masked using the bytes of the diversified mask 14 to supply the masked datum 15.

In order to unmask the masked datum 15, the latter is stored in the communicating object together with the diversifier D used to generate the diversified mask 14, which means with the diversifier for obtaining it. The masked datum 15 is thus associated with the diversifier D.

When writing or creating another datum in the card, another diversifier will be generated, preferably in a random way, so as to generate another diversified mask which will be used for masking such other datum.

The advantage of the invention is that it is possible to generate as many diversified masks as there are bytes or bits in the master mask 11. Storing the diversifier D requires little space in the memory, typically one byte.

In order to reinforce the security of the method according to the invention, it is possible to use more than one master mask, for example two, and to generate two diversifiers D1 and D1. The diversifier D1 will be applied to the first master mask and the diversifier D2 to the second master mask. Each byte of a datum to be masked will be masked, for example using the Exclusive-or function, by a byte of the first diversified mask and by a byte of the second diversified mask. The diversifiers D1 and D2 will then be stored together with the masked data. For a 256-byte master mask, it will then be possible to generate 256² different masks.

The invention applies particularly well in a Java environment and the diversifiers can be stored with the header of the Java objects.

The reversible Exclusive-Or function is not the only one which can be used: it is possible to use a DES function or a simple rotation. Any reversible function is suitable for the invention.

The diversifier D is preferably generated in a random or pseudo-random way when the data 10 is written/created in the communicating object or upon each starting of the communicating object.

From one communicating object to another, the master masks 11 are preferably diversified. This ensures that, in the case of a successful attack on a communicating object, the attacker having a master mask cannot unmask the masked data in another communicating object.

The invention can be applied to any communicating object, such as for example portable phones and preferably to chip cards, for example multi-application chip cards.

1. A method for generating masks in a communicating object, said masks being intended to mask data to be stored in said communicating object, at least one master mask being stored in said communicating object, said method comprising:
applying at least one diversifier to said master mask, so as to generate a diversified mask;
masking said datum to be stored in said communicating object by a reversible function using said diversified mask, said mask generating a masked datum;
storing said masked datum in said communicating object with the diversifier used for generating the diversified mask, to thereby make it possible to obtain said masked datum.

2. A method according to claim 1, wherein said reversible function is an Exclusive-Or function.

3. A method according to claim 1, wherein said application of a diversifier to said master mask comprises applying a rotation to said master mask.

4. A method according to claim 1, wherein said diversifier is generated in a pseudo-random manner in said communicating object.

5. A method according to claim 1, wherein a plurality of master masks are diversified from one communicating object to another, respectively.

6. A communicating object including means for implementing a method according to claim 1.

7. A communicating object according to claim 6, comprising a chip card.
